(19) United States
(12) Patent Application Publication
(10) Pub. No.: US 2022/0246177 A1
(43) Pub. Date: Aug. 4, 2022

(54) MULTI-SPEED HARD DISK DRIVE

(71) Applicant: Seagate Technology LLC, Fremont, CA (US)

(72) Inventors: Xiong Liu, Singapore (SG); Feng Shen, Singapore (SG)

(21) Appl. No.: 17/166,198

(22) Filed: Feb. 3, 2021

(51) Int. Cl. G11B 17/04

(52) U.S. Cl. CPC G11B 17/0401

(57) ABSTRACT

A hard disk drive includes a base deck, a motor coupled to the base deck, a magnetic recording medium coupled to the motor and having a first zone and a second zone, and a controller. The controller is programmed to cause the motor to rotate at either a first speed or a second speed when data is to be read from the first zone and to cause the motor to rotate at the first speed when data is to be written to the first zone and the second zone.

### SUMMARY

In certain embodiments, a hard disk drive includes a base deck, a motor coupled to the base deck, a magnetic recording medium coupled to the motor and having a first zone and a second zone, and a controller. The controller is programmed to cause the motor to rotate at either a first speed or a second speed when data is to be read from the first zone and to cause the motor to rotate at the first speed when data is to be written to the first zone and the second zone.

In certain embodiments, an integrated circuit includes firmware for causing a motor to rotate at a first speed or a second speed. Causing the motor to rotate at the first speed or the second speed is based, at least in part, on whether a write command is associated with a first address located in a first zone of a magnetic recording medium and whether a read command is associated with a second address located in either the first zone or a second zone. Causing the motor to rotate at the first speed is based, at least in part, on whether a write command is associated with a third address located in a second zone of the magnetic recording medium.

In certain embodiments, a method includes writing data to a first zone and a second zone of a magnetic recording medium, rotating a motor at a first speed when data is being written to the first zone and the second zone, reading data from the first zone and the second zone, and rotating the motor at a second speed when data is being read from the first zone and the second zone, the second speed being greater than the first speed.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 shows a block diagram of a data storage device, in accordance with certain embodiments of the present disclosure.

FIG. 2 shows an exploded view of a hard disk drive, in accordance with certain embodiments of the present disclosure.

FIG. 3 shows a top view of a magnetic recording medium, in accordance with certain embodiments of the present disclosure.

FIG. 4 shows a top view of a portion of the magnetic recording medium of FIG. 3, in accordance with certain embodiments of the present disclosure.

FIG. 5 shows a block representation of steps in methods for operating a motor at different speeds, in accordance with certain embodiments of the present disclosure.

While the disclosure is amenable to various modifications and alternative forms, specific embodiments have been shown by way of example in the drawings and are described in detail below. The intention, however, is not to limit the disclosure to the particular embodiments described but instead is intended to cover all modifications, equivalents, and alternatives falling within the scope of the appended claims.

### DETAILED DESCRIPTION

Certain embodiments of the present disclosure involve operating motors of hard disk drives at different speeds during certain conditions to increase areal density. In particular, certain embodiments of the present disclosure involve rotating motors at lower speeds when writing data such that more data can be written in a given area, compared to when motors are operated at higher speeds. It has been found that, given certain constraints, hard disk drives can increase areal density by writing data when operating a motor at lower speeds.

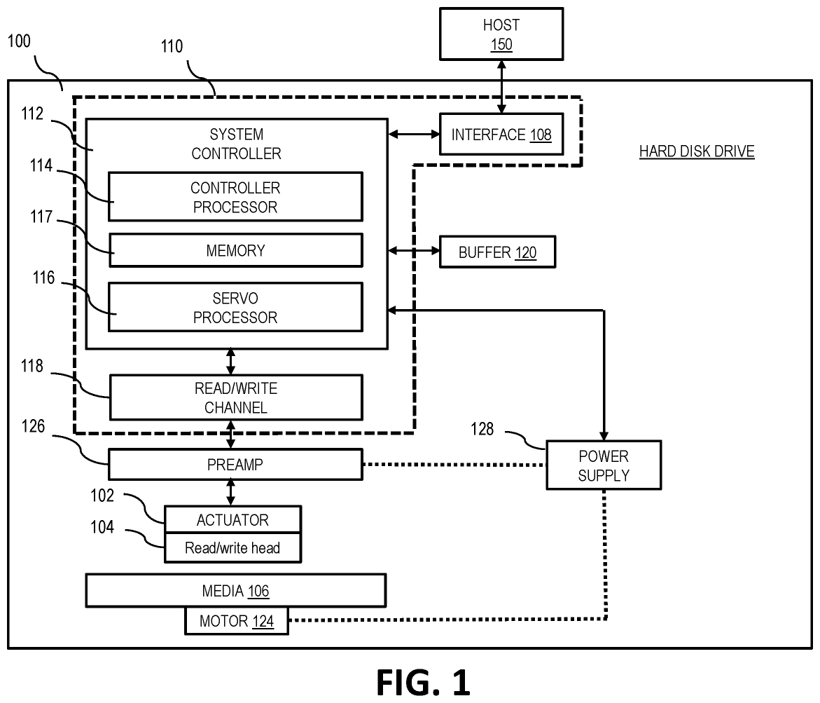

FIG. 1 shows a schematic of a hard disk drive 100. The hard disk drive 100 includes an actuator 102 with one or more read/write heads 104 to provide access to magnetic recording media 106 (multiple magnetic recording disks, which are referred to as a magnetic recording medium in the singular). Although only one actuator is shown in FIG. 1, additional actuators can be incorporated into hard disk drive 100.

The hard disk drive 100 includes an interface 108 (e.g., an input/output interface) for transferring data to and from the hard disk drive 100. For example, the interface 108, among other features, can be communicatively coupled between a host 150 (e.g., a data storage system such as a server or laptop) and the read/write heads 104 to facilitate communication, using a standardized communication protocol, between the read/write heads 104 and the host 150.

The hard disk drive 100 includes a system on a chip (“SOC”) 110 (shown in dashed lines) that includes a system controller 112, which can include a controller processor 114 (e.g., a microprocessor), a servo processor 116 (e.g., a microprocessor), and memory 117 coupled to the controller processor 114 and the servo processor 116. The interface 108 may also be part of the SOC 110. The SOC 110 can also include one or more read/write channels 118, which can encode data associated with write commands and decode data associated with read commands. The SOC 110 may be an integrated circuit such as an application-specific integrated circuit (“ASIC”) and field-programmable gate array (“FPGA”) that includes instructions (e.g., in the form of firmware) stored in memory for carrying out various functions of the data storage device 100. For example, the SOC 110 can include circuitry to control and carry out various aspects of the hard disk drive 100 as described in more detail below. Although the interface 108, the system controller 112, etc., are shown as being part of a single SOC, the components and their functions can be distributed among several integrated circuits.

The system controller 112 can be coupled to and control access to a buffer 120, which can temporarily store data associated with read commands and write commands. The buffer 120 can be a volatile memory, such as a dynamic random access memory (“DRAM”), static random access memory (“SRAM”), or other volatile memory.

During operation, the hard disk drive 100 receives various data transfer commands (e.g., a read command or a write command) from the host 150. Data associated with a write command may be received from the host 150 by the interface 108 and initially stored to the buffer 120. The data is encoded or otherwise processed by the read/write channel 118 and eventually stored to the magnetic recording media 106 via one of the read/write heads 104. For example, the magnetic writer portion of the read/write heads 104 can emit a magnetic field towards a surface of the magnetic recording media 106, which “writes” data in the form of magnetic transitions on the magnetic recording media 106. Data associated with a read command may be retrieved from the magnetic recording media 106 by the read sensor portion of the read/write heads 104 and stored in the buffer 120. For example, the read sensor may sense the magnetic transitions written to the magnetic recording media 106. Such data is then transferred to the host 150 by the interface 108.

The data storage device 100 includes a servo control system that is carried out by components of the system controller 112 (e.g., the servo processor 116 and the memory 117). The servo control system controls positioning (e.g., rotation) of the actuator via a voice coil motor (VCM) assembly and can control actuation of microactuators to position the read/write heads 104 over a desired data track on the magnetic recording media 106 for reading and writing operations.

During operation, a spindle motor 124 rotates the magnetic recording media 106. The actuator 102 is driven by the VCM assembly to pivot around a pivot bearing. The VCM assembly and any microactuators are arranged to carry out various positioning operations (e.g., track seeking, track settling, track following) that position the read/write heads 104 over a desired data track of the magnetic recording media 106 to read data from or write data to the desired data track. For example, in response to a command to read data from or write data to a data track located a certain distance away from where the read/write head 104 is currently positioned (i.e., a track-seeking operation), a current may be applied to the voice coil of the VCM assembly to rotate the actuator 102 (and therefore the read/write head 104) towards the desired data track. As the read/write head 104 nears the desired data track, less current is applied to the VCM assembly such that the read/write head 104 begins to settle over the desired data track (i.e., a track-settling operation). Once the read/write head 104 is positioned over the desired data track, the servo control system compensates for small positioning errors (i.e., a track-follow operation) to keep the desired read/write head 104 over the desired data track on the magnetic recording medium 106 during a read operation or a write operation.

In certain embodiments, the controller processor 114 controls operations of a pre-amplifier 126, which provides signals to the read/write head 104 for writing magnetic transitions to the magnetic recording media 106 and for receiving signals from the read/write heads 104 in response to detecting magnetic transitions written to the magnetic recording media 106.

As shown in FIG. 1, the hard disk drive 100 includes a power supply 128, which can be controlled by the system controller 130. The power supply 128 supplies current to the motor 124 and the VCM assembly. In certain embodiments, the power supply 128 is an integrated circuit. For example, the power supply 128 may include a pulse-width-modulated-based current feedback amplifier driver circuit or transconductance amplifier driver circuit (e.g., either of which may comprise class D amplifier circuitry).

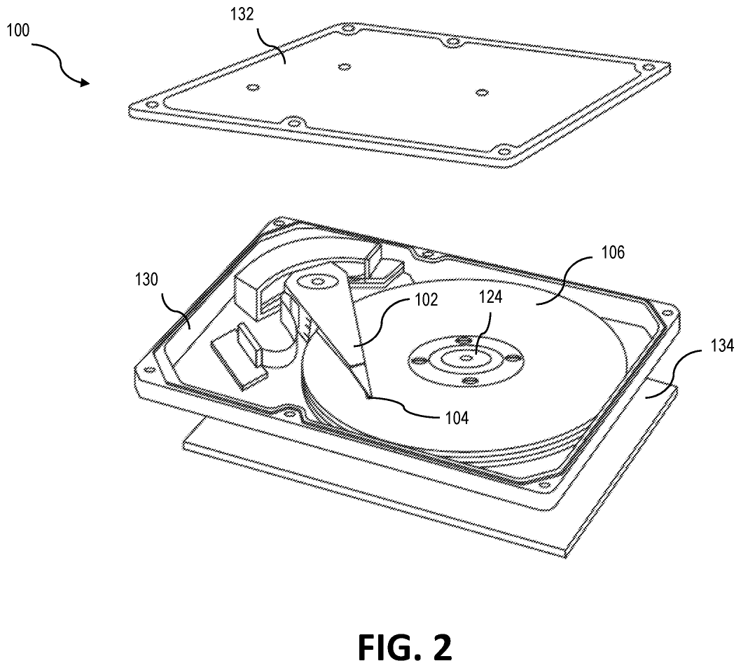

FIG. 2 shows additional features of the hard disk drive 100 such as a base deck 130 and a top cover 132 that house various components of the hard disk drive 100, some of which are described above and also represented in FIG. 1. FIG. 2 also shows a circuit board 134 to which the SOC 110 can be electrically and mechanically coupled to, along with other circuitry such as the power supply 128.

Spindle motors in hard disk drives typically utilize fluid dynamic bearings and are designed and used for particular advertised rated speeds (e.g., a predetermined rated speed). For example, spindle motors in hard disk drives are typically operated at speeds around advertised rated speeds such as 3,600 revolutions per minute (rpm); 4,200 rpm; 5,400 rpm; 7,200 rpm; 10,000 rpm; or 15,000 rpm. The specific actual operating speeds of the motors may vary somewhat from the rated speeds but are typically within a few hundred rpms of the rated speed. For example, a 10,000 rpm motor may actually operate at or around 10,500 rpm in a hard disk drive. In another example, a 7,200 rpm motor may actually operate at our around 7,250 rpm in a hard disk drive. As such, the rated speeds may not be the exact same as the actual operating speeds of spindle motors in hard disk drives. The rated speed (and therefore the associated actual operating speed) for a given spindle motor design is dependent on features such as the number of stator windings, the size of fluid bearings, and various dimensions of the motor.

As noted above, the hard disk drive 100 of the present disclosure can operate the motor 124 at different speeds, depending on certain circumstances, to increase areal density of the hard disk drive 100. The description below outlines such circumstances and approaches for increasing areal density.

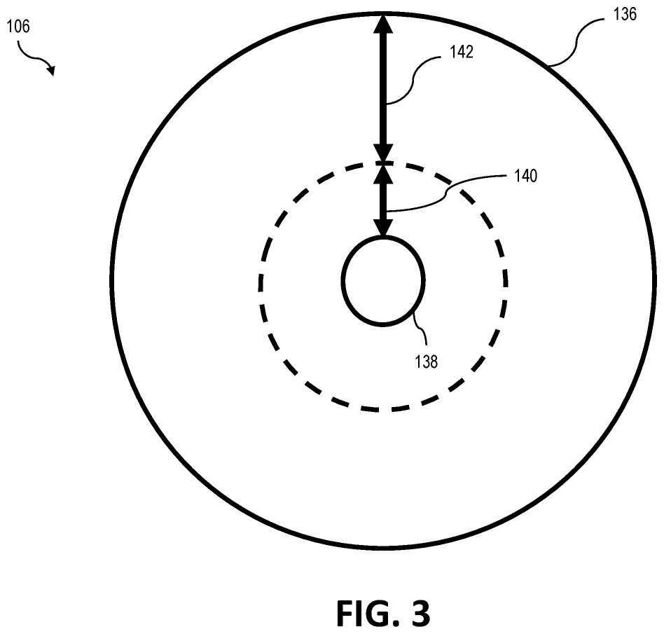

FIG. 3 shows a top view of one side (or one recording surface) of one of the magnetic recording media 106. Because only one of the magnetic recording media 106 is shown in FIG. 3, the description below may refer to the media 106 as the medium—the singular form of media—but it is to be understood that the features shown in FIG. 3 can be used in connection with any and all of the magnetic recording media 106 of the hard disk drive 100.

Data is written to the magnetic recording medium 106 along tracks, which may be sequentially numbered in accordance with their radial position. For example, track zero may be located adjacent to an outer diameter 136 of the magnetic recording medium 106 and a last track may be located adjacent to an inner diameter 138 of the magnetic recording medium 106.

The tracks of the magnetic recording medium 106 can include user data regions and servo data regions (which are sometimes referred to as servo wedges) positioned between the user data regions. The servo wedges extend radially between an inner diameter 138 and an outer diameter 136 of the magnetic recording medium 106. Data on the magnetic recording media 106 is stored on data tracks which extend circumferentially around the top/bottom surfaces of each magnetic recording medium 106.

FIG. 3 shows the magnetic recording medium 106 including a first zone 140 and a second zone 142. As will be described in more detail below, the zones can be used in conjunction with determining or selecting the speed at which the motor 124 rotates. Although in FIG. 3 the first zone 140 is shown as being positioned between the inner diameter 138 and the second zone 142, in other embodiments the first zone 140 (and its features described below) can be positioned between the outer diameter 136 and the second zone 142. Further, although only two zones are shown in FIG. 3, the magnetic recording medium 106 can include additional zones.

Each zone includes its own data sectors and data tracks, which, as described above, are sequentially numbered in accordance with their radial position. Data written to the magnetic recording media 106 is associated with an address (e.g., logical block address). For example, an electronic file (e.g., a digital photograph or a digital audio file) stored to the magnetic recording medium 106 can be associated with an address or addresses that indicate the starting and ending location of the magnetic transitions that represent the electronic file. When data is to be written or read, the hard disk drive 100 uses these addresses to know where to locate the data on the magnetic recording media 106.

In certain embodiments, when data is written to data tracks located in the first zone 140 and the second zone 142, the motor 124 is operated to rotate at a speed that is lower than the rated speed of the motor 124. For example, if the motor 124 is rated as a 7,200 rpm motor, the motor 124 can rotate at 3,000 to 6,000 rpm (e.g., ˜3,600 rpm; ˜4,200 rpm; ˜5,400 rpm) when data is being written to data tracks in the first zone 140 and the second zone 142. As another example, the motor 124 can rotate 1,000 rpm-4,000 rpm lower than the rated speed of the motor 124 when data is being written to data tracks in the first zone 140 and the second zone 142.

By rotating the motor 124 at a lower speed when writing data, adjacent bits of data can be written closer together (and achieve comparable bit error rates) than if the data was written while the motor 124 was rotating faster. Because the rise time of current of the writer portion of the read/write head 104 (e.g., the time it takes for the writer to change between a positive current and negative current) does not change with motor speed, more bits can be written within a data track. As such, given the constraint on the rise times of writer current, more bits can be written to a given area of the magnetic recording media 106 when the motor rotates slower, thereby increasing the areal density of the hard disk drive 100.

In some embodiments, the motor 124 is operated to rotate at the rated speed of the motor 124 when certain data (e.g., cache data) is written to data tracks located in the first zone 140 but not the second zone 142. As such, for write operations, the first zone 140 can be considered to be a multi-speed zone or multi-rpm zone (e.g., dual-speed writing zone or dual-rpm writing zone). The second zone 142 can be considered to be a single-speed writing zone or single-rpm writing zone—although the precise rotating speed of the motor 124 may vary slightly (e.g., ±10 rpms) depending on environmental conditions over time. Given that the first zone 140 consumes less area of the magnetic recording media 106 than the second zone 142, writing some data at higher speeds in the first zone 140 does not have a large impact on the overall areal density of the hard disk drive 100. For example, in some embodiments, the first zone 140 consumes less than 5% (e.g., 1-3%) of the overall surface area of the magnetic recording medium 106.

In certain embodiments, the motor 124 can be operated at the rated speed or at a lower speed when data is read from data tracks located in the first zone 140 or the second zone 142. For example, in situations where the hard disk drive 100 receives a command from a host requiring high sequential data throughput, the motor 124 can be operated at the rated speed (or higher) to meet the demands of the command. Rotating the magnetic recording media 106 faster increases the amount of data that can be read during a given period of time. As such, for read operations, the first zone 140 and the second zone 142 can be considered to be multi-speed zones or multi-rpm zones (e.g., dual-speed reading zones or dual-rpm reading zone).

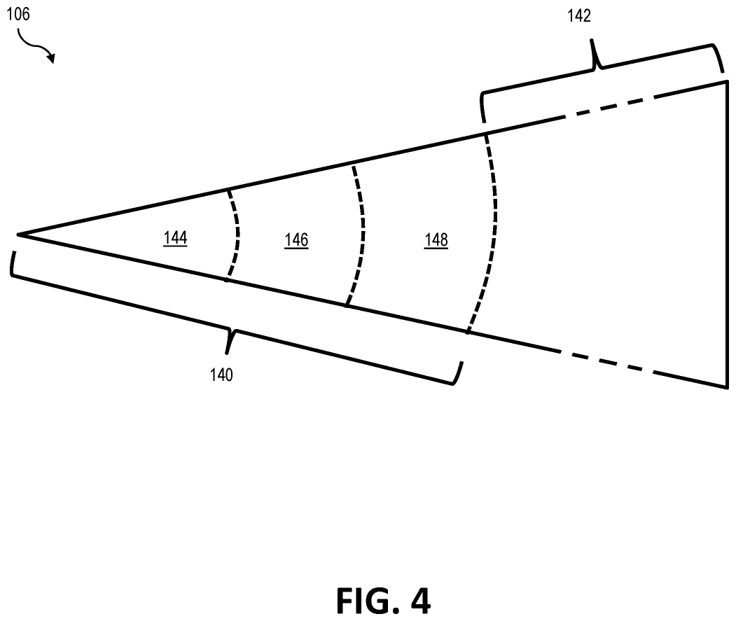

FIG. 4 shows a portion of the magnetic recording medium 106 shown in FIG. 3. As shown in FIG. 4, the first zone 140 includes multiple subzones 144, 146, and 148. These subzones represent areas within the first zone 140 that are reserved or designated for particular types of data. Because, as described above, data written to the first zone 140 can be written while the motor 124 rotates at a higher or lower speed, these subzones can be used for types of data that may need to be written at a higher speed under certain conditions.

As one example subzone, the first zone 140 can include a media cache subzone 144. The media cache subzone 144 may be reserved for situations where data needs to be temporarily stored to the magnetic recording medium 106 in the event of a write error or before the data is able to be written to its assigned address. The media cache subzone 144, therefore, can help increase data throughput of the hard disk drive 100 or assist with addressing temporary errors.

As another example, the first zone 140 can include a hard disk drive (HDD) system data subzone 146. The HDD system data subzone 146 can be used to store information about the hard disk drive 100 itself. For example, the HDD system data subzone 146 may store data such as manufacturing data of the hard disk drive 100, temperature data, workload data, and other types of data.

The first zone 140 can also include a host system data subzone 148. The host system data subzone 148 can be used to store information about the host, which the hard disk drive 100 is communicatively coupled to. For example, the host system data subzone 148 can data about the host's file system and file management. The first zone 140 can allocate space to store other types of data/events during operation of the hard disk drive 100 such as user data and servo data too.

In embodiments with more than two zones, the subzones described immediately above can be split between the multiple zones. For example, in some embodiments, the media cache subzone 144 is positioned near the outer diameter 136 for faster access speeds while the other subzones are positioned near the inner diameter 138.

As noted above, circuitry such as one or more of the controllers of the SOC 110 of the hard disk drive 100 can be programmed to carry out the various functions and steps described herein. The circuitry may be programmed via firmware, which can include instructions for carrying out the various functions.

As such, one or more of the controllers can be programmed to cause the motor 124 to rotate at either a first speed (e.g., a lower speed) or a second speed (e.g., a higher speed) when data is to be read from the first zone 140 and/or the second zone 142. Further, the controller(s) can be programmed to cause the motor 124 to rotate at the first speed when data is to be written to the second zone 142 and, in certain circumstances, the first zone 140.

The controller(s) may select the speed of the motor 124 in response to a command from the host 150. For example, the host 150 may request or cause the motor 124 spin faster when the host 150 requires high data throughput. As another example, the controller(s) may select the speed of the motor 124 depending on an address associated with data to be written or read. For example, if data is to be written to an address within the first zone 140, the controller may select a higher speed if the address is within the media cache subzone 144 or a lower speed if the address is within the HDD system data subzone 146. On the other hand, the controller(s) may be programmed to always select the lower speed if the address of data to be written is located within the second zone 142. In some embodiments, the default speed of the motor 124 is a lower speed unless the controller(s) receive a request to increase the motor speed.

In certain embodiments, the controller(s) cause the motor 124 to increase or decrease in speed by sending a command to the power supply 128 to supply more or less current to the motor 124.

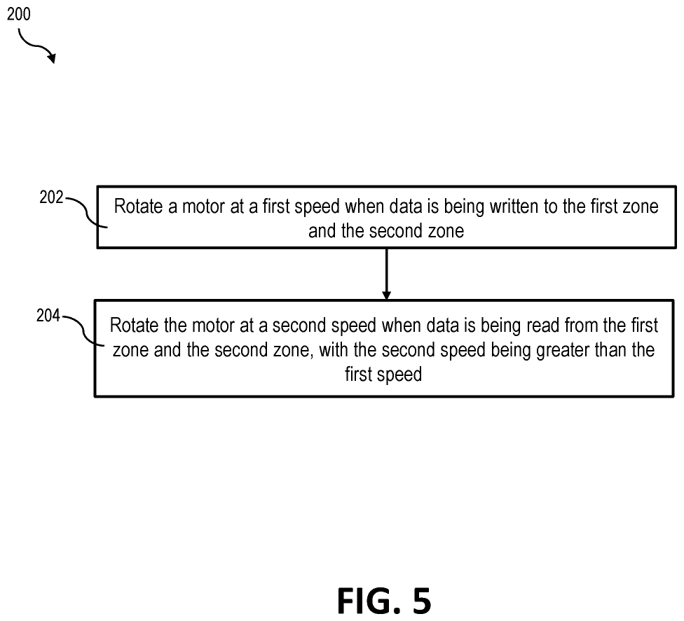

FIG. 5 outlines steps of a method 200 for controlling the speed of the motor 124. The method 200 includes rotating the motor 124 at a first speed when data is being written to the first zone 140 and the second zone 142 (block 202 in FIG. 5). The method 200 also includes rotating the motor 124 at a second speed when data is being read from the first zone 140 and the second zone 142, with the second speed being greater than the first speed (block 204 in FIG. 5).

Various modifications and additions can be made to the embodiments disclosed without departing from the scope of this disclosure. For example, while the embodiments described above refer to particular features (e.g., data storage devices with dual actuators), the scope of this disclosure also includes embodiments having different combinations of features (e.g., data storage devices with a single actuator or four actuators) and embodiments that do not include all of the described features. Accordingly, the scope of the present disclosure is intended to include all such alternatives, modifications, and variations as falling within the scope of the claims, together with all equivalents thereof.

1. A hard disk drive comprising:
a base deck;
a motor coupled to the base deck and arranged to rotate at a first speed and a second speed, the first speed has a lower rotational speed than the second speed;
a magnetic recording medium coupled to the motor and having a first zone and a second zone; and
a controller programmed to:
cause the motor to rotate at either the first speed or the second speed when data is to be read from the first zone and the second zone,
cause the motor to rotate at the first speed or the second speed when data is to be written to the first zone, and
cause the motor to rotate at only the first speed when data is to be written to the second zone.

2. The hard disk drive of claim 1, wherein the first zone includes a media cache, system data, and host data.

3. The hard disk drive of claim 2, wherein the controller is further programmed to cause the motor to rotate only at the second speed when data is to be read from the media cache.

4. (canceled)

5. The hard disk drive of claim 1, wherein the first speed is 3,000-6,000 rpm, wherein the second speed is 7,000-12,000 rpm.

6. (canceled)

7. The hard disk drive of claim 1, wherein the first zone is positioned between an inner diameter of the magnetic recording medium and the second zone.

8. (canceled)

9. The hard disk drive of claim 1, wherein the first speed or the second speed is selected based, at least in part, on an address of data to be read or written.

10. The hard disk drive of claim 1, wherein the second speed is a rated speed of the motor.

11. The hard disk drive of claim 1, wherein the controller is programmed to cause the motor to rotate at either the first speed or the second speed in response to a command from a host.

12. An integrated circuit comprising:
firmware for causing a motor to:
rotate at either a first speed or a second speed when data is to be read from a first zone of a magnetic recording medium and a second zone of the magnetic recording medium, wherein the first speed is a lower rotational speed than the second speed,
rotate at the first speed or the second speed when data is to be written to the first zone, and
rotate at only the first speed when data is to be written to the second zone.

13. (canceled)

14. The integrated circuit of claim 12, wherein the first speed is 3,000-6,000 rpm, wherein the second speed is 7,000-12,000 rpm.

15. The integrated circuit of claim 12, wherein the firmware further causes the motor to rotate at only the second speed when data is to be read from a media cache in the first zone.

16. The integrated circuit of claim 12, wherein the second speed is a rated speed of the motor.

17. The integrated circuit of claim 12, wherein the first speed is less than the second speed by 1,000-4,000 rpm.

18. The integrated circuit of claim 12, wherein the firmware further causes the motor to rotate at either the first speed or the second speed in response to a command from a host.

19. A method comprising:
writing data to a first zone of a magnetic recording medium;
writing data to a second zone of the magnetic recording medium;
rotating a motor at either a first speed or a second speed when data is being written to the first zone;
rotating the motor only at the first speed when data is being written to the second zone;
reading data from the first zone;
reading data from the second zone; and
rotating the motor at either the first speed or the second speed when data is being read from the first zone and the second zone, the second speed being greater than the first speed.

20. The method of claim 19, wherein the second speed is greater than the first speed by 1,000-4,000 rpm.

21. The method of claim 19, further comprising: rotating the motor only at the second speed when data is to be read from a media cache in the first zone.

22. The method of claim 19, wherein the first zone includes a media cache, system data, and host data.

23. The hard disk drive of claim 1, wherein the first zone and the second zone are predefined areas of the magnetic recording medium.

24. The hard disk drive of claim 1, wherein the first zone consumes 5% or less of an entire surface area of the magnetic recording medium.
